(19) United States
(12) Patent Application Publication
(10) Pub. No.: US 2024/0263550 A1
(43) Pub. Date: Aug. 8, 2024

(54) METHODS FOR REPURPOSING THERMAL HYDROCARBON RECOVERY OPERATIONS FOR SYNTHESIS GAS PRODUCTION

(71) Applicant: PROTON TECHNOLOGIES CANADA INC., Calgary, (CA)

(72) Inventors: Grant D. STREM, NW Calgary, Alberta (CA); Ian D. GATES, NW Calgary, Alberta (CA); Jingyi WANG, SW Calgary, Alberta (CA)

(73) Assignee: PROTON TECHNOLOGIES CANADA INC., SW Calgary, Alberta (CA)

(21) Appl. No.: 18/268,056

(22) PCT Filed: Dec. 14, 2021
(86) PCT No.: PCT/CA2021/051803

§ 371 Date: Jun. 16, 2023

Related U.S. Application Data
(60) Provisional application No. 63/127,754, filed on Dec. 18, 2020.

(51) Int. Cl. E21B 43/24; C01B 3/04; C01B 3/14; C01B 3/34; C01B 3/50

(52) U.S. Cl. CPC E21B 43/2406; C01B 3/045; C01B 3/14; C01B 3/34; C01B 3/501; C01B 2203/0205; C01B 2203/0283; C01B 2203/041

(57) ABSTRACT

Methods for repurposing thermal hydrocarbon recovery operations where the reservoir, which has been previously treated with steam for hydrocarbon mobilization, is further treated with an oxidizer to induce one or more of thermal cracking (thermolysis), gasification, water-gas shift, and aquathermolysis reactions to generate synthesis gas within the reservoir, which synthesis gas or its constituent components can then be produced to surface.

### TECHNICAL FIELD OF THE INVENTION

The technical field relates to production of valuable products from hydrocarbon reservoirs, and specifically to secondary or tertiary methods for treating reservoirs.

### BACKGROUND OF THE INVENTION

Hydrocarbon reservoirs are abundant globally and many technologies are used to produce oil or gas from these reservoirs including primary processes as well as enhanced oil recovery processes such as water flooding and steam flooding and chemical flooding to produce additional hydrocarbon from reservoirs.

For various oil types including but not limited to heavy oil and extra heavy oil (bitumen), various reservoir factors challenge or impair the producibility of the oil including if the oil is highly viscous at original reservoir conditions, and so various oil types including but not limited to heavy oil and bitumen are commonly thermally treated to lower viscosity and possibly increase reservoir pressure so that the hydrocarbon flows easier in the reservoir and can be produced to the surface. In most thermal methods, steam is injected into the reservoir to heat the heavy oil or bitumen to lower its viscosity so that it can be produced to the surface. In some cases alternative augmentative heating methods other than steam are used or methods in addition to steam are used which may include injection of surfactants or miscible fluids, or many other methods.

Steam-Assisted Gravity Drainage (SAGD) is one of the two most common steam-based recovery processes for producing bitumen. FIGS. 1 and 2 illustrate a conventional SAGD process 1. In a SAGD thermal recovery operation such as the illustrated process 1, a production well 2 is drilled into a lower region of the target reservoir 3, and an injection well 4 is drilled above the production well 2 for injecting steam 5 (with or without additives). As the steam 5 is injected into the reservoir 3 through the open injection well 4, it heats and mobilizes the hydrocarbon housed within the reservoir 3, which mobilized hydrocarbon flows downwardly through the reservoir 3 due to gravity toward the production well 2, as fluids 8 (oil, water and gas) are produced to surface through the open production well 2. A hydrocarbon-depleted steam chamber 9 forms in the reservoir 3 due to the injection and production actions as hydrocarbon is liberated from the reservoir 3, as shown in a side view 6 and a cross sectional view 7. As can be seen in FIG. 2, over time the steam chamber 9 expands outwardly from the injection and production wells 4, 2.

Cyclic steam stimulation (CSS) is another commonly used steam-based recovery process for producing bitumen. In a conventional CSS system, a single well (normally vertical) is used to inject steam (with or without additives) into a target reservoir. The well is then closed off and the injectant is allowed to heat and mobilize hydrocarbon within the reservoir. The well is then converted into production mode and used to produce the mobilized hydrocarbon to surface. Again, a steam chamber forms around the well in the reservoir as the hydrocarbon is mobilized and extracted.

Other variant processes add solvent or non-condensable gas to the steam during the process to mobilize more bitumen or to improve the thermal efficiency of the recovery process.

At some point in time, the heavy oil or bitumen production rate of steam-based recovery processes, or their variants using solvent or non-condensable gas additives to the steam, drops to the point that the process is not economic to operate. At such a point it is common to shut down the well.

There is a need to find other options to extend the useful and economic life of such thermal recovery operations.

### SUMMARY OF THE INVENTION

In broad aspects, methods and systems described herein make use of previously steamed reservoirs from SAGD or CSS or other steam-based recovery operations and variants of these processes (e.g., that used solvent or non-condensable gas co-injection with steam) where steam injection is stopped and air or oxygen or another oxidizer is injected into the steam chamber in the reservoir to cause oxidation, thermal cracking (thermolysis), aquathermolysis, gasification, and/or water-gas shift reactions, and other reactions, so that a synthesis gas is generated in the reservoir, which gas or its constituent components can be produced to surface. The steam-based recovery may be either a primary or secondary extraction technique.

In a first broad aspect of the present invention, there is provided a method of repurposing a thermal hydrocarbon recovery system to produce synthesis gas from a post-steamed portion of a reservoir after termination of hydrocarbon recovery, the thermal hydrocarbon recovery system comprising at least one well from surface to the reservoir, the method comprising the steps of:
a. operating the thermal hydrocarbon recovery system to mobilize and extract hydrocarbon from the reservoir through steam injection and mobilized hydrocarbon production using the at least one well, resulting in the post-steamed portion of the reservoir adjacent the at least one well containing oxidizable materials;
b. terminating the steam injection and mobilized hydrocarbon production;
c. injecting an oxidizing agent into the post-steamed portion of the reservoir through the at least one well to cause combustion of the oxidizable materials;
d. allowing the combustion of the oxidizable materials to cause at least one of thermal cracking, aquathermolysis, gasification, and water-gas shift reactions to occur within the post-steamed portion of the reservoir to form synthesis gas; and
d. producing at least one constituent component of the synthesis gas to surface through the at least one well.

In some exemplary embodiments of the first broad aspect of the present invention, at least one of steam, solvent, carbonate, boiler blowdown water, calcium hydroxide, raw sewage, sea water, and waste water is co-injected with the oxidizing agent. The oxidizing agent is preferably selected from air and oxygen.

In some exemplary embodiments, the at least one well is closed off after step c. to allow the combustion to cause the at least one of thermal cracking, aquathermolysis, gasification, and water-gas shift reactions of step d.

The synthesis gas preferably comprises hydrogen and carbon oxides. Steps c. to e. may be repeated when the at least one constituent component of the synthesis gas being produced to the surface through the at least one well drops below a selected threshold volume. Where the at least one constituent component is the hydrogen, the method preferably further comprises the step after step d. of using a membrane to allow production of only the hydrogen to the surface.

The thermal hydrocarbon recovery system may be a steam-assisted gravity drainage system and the at least one well can then be an injector well and a producer well, and either or both of the injector well and the producer well may be used for the steps of injecting the oxidizing agent and producing the at least one constituent component of the synthesis gas to the surface. The steam-assisted gravity drainage system may comprise at least one infill well and the at least one well then comprises the at least one infill well. The at least one well may be at least one of a horizontal well, a vertical well, a deviated well and a multilateral well. The at least one well may be a dual completion well, wherein the steps of injecting the oxidizing agent and producing the at least one constituent component of the synthesis gas to the surface occur at different portions of the dual completion well. The at least one well may further comprise flow control devices to control where along the at least one well the injecting of the oxidizing agent and the producing of the at least one constituent component of the synthesis gas occur.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIGS. 1 and 2 illustrate stages of a prior art SAGD process.

FIG. 3 illustrates an oxidizing agent injection stage of one exemplary embodiment of the present invention, wherein an oxidizing agent is injected into a steam chamber established during a steam-based recovery process.

FIG. 4 illustrates a production stage of the exemplary embodiment of FIG. 3.

FIG. 5 illustrates another exemplary embodiment of the present invention, after steam-based recovery has stopped, wherein an oxidizing agent is injected into the formation and synthesis gas is produced from the reservoir (with other reservoir fluids) simultaneously.

Exemplary embodiments will now be described with reference to the accompanying drawings.

### DETAILED DESCRIPTION OF EXEMPLARY EMBODIMENTS

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present invention is directed to producing valuable products from reservoirs that have been subjected to primary or secondary recovery involving steam injection resulting in a hydrocarbon-depleted steam chamber. The methods described herein may thus take advantage of the invested heat in the reservoir (from steam injection into the reservoir) as well as the presence of steam in the reservoir which helps, together with injection of an oxidizer, to achieve gasification and water-gas shift reactions to yield synthesis gas in the reservoir. The synthesis gas or a portion of the synthesis gas is then produced from the reservoir and can be used as a chemical feedstock for chemical products, e.g., methanol, ammonia, carbon fiber, or as a fuel for steam generation or electricity production; for example, within internal combustion engines or fuel cells.

During synthesis gas production, mobilized petroleum products including heavy oil or bitumen or methane can also be produced from the reservoir.

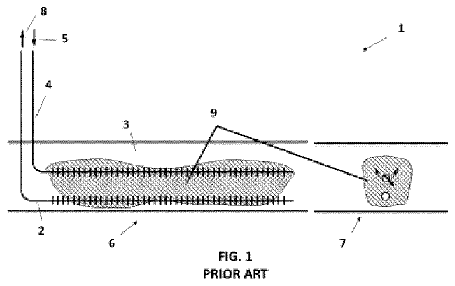

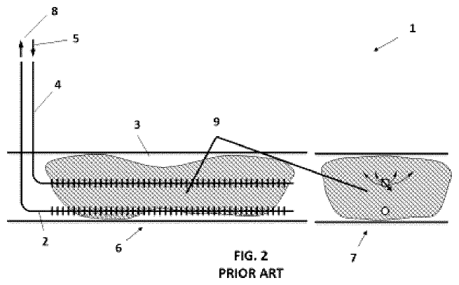

In general, the present specification describes methods to treat hydrocarbon reservoirs (conventional oil, heavy oil, oil sands reservoirs, carbonate oil reservoirs, natural gas, hydrogen sulphides) that have previously been subject to stream treatment, to recover synthesis gas, such previous treatment illustrated in one exemplary SAGD method in FIGS. 1 and 2 and described above. Exemplary methods according to the present invention include injection of oxygen or a rich-oxygen stream into the post-steamed reservoir to combust a fraction of the oxidizable fluids and/or solids in the reservoir, the steam chamber now becoming a reaction zone for gasification, water-gas shift, thermal cracking (thermolysis) and/or aquathermolysis. Delivery of the pure or impure oxygen can be co-injected with steam and/or with other fluids including solvents, or by itself. Co-injection of steam has the added benefit that steam is a condensable fluid and a useful heat-transfer fluid. During this part of the process, fluids do not need to be but might be produced to the surface. After the target temperature is achieved in the reservoir, oxygen injection may stop or be reduced, and the reservoir is allowed to soak during which time remaining oxygen in the reservoir may be consumed and gasification reactions and the water-gas shift reaction take place. This phase could include continuation of injection of other fluids such as steam/water and/or solvents. During these reactions, hydrogen and carbon oxides are produced within the reservoir. The production well when opened for production produces a mixture of hydrogen, carbon oxides, water (as part of the synthesis gas), hydrocarbon gases, and hydrogen sulphides to the surface. Alternatively, if a downhole hydrogen membrane or filter such as a palladium-alloy membrane or carbon-based filter is in use, hydrogen may be produced to surface in elevated purity. After the synthesis gas and/or hydrogen production rate drops to a threshold value, then oxygen injection might start once again or increase and the process can be repeated multiple times of similar or variable duration, until the overall synthesis gas production rate drops to a threshold value. Thus, the process yields synthesis gas or hydrogen-enriched gas from the hydrocarbons and water that sit within the reservoir due to the previous steam-based recovery techniques applied to the reservoir. Water or steam or combustible fuels or waste products such as organic material or sewage, or other fluids or particles or catalysts, or dissolved ions may be injected into the reservoir with the oxygen or separately from it.

In some exemplary embodiments, an oxidizer is injected into one or more wells and production of synthesis gas can be achieved from another well or wells. In another embodiment, the oxidizer can be injected into a well and then after some time of injection, injection is stopped and then the well is put into production to produce synthesis gas and/or other reservoir fluids including but not limited to oil or hydrogen. Within a single oil field, various wells may be injecting or producing alternately or simultaneously or quiescently.

In a post-SAGD reservoir, such as in the illustrated embodiments, the injection and production wells of a single well pair can be used either with one or both wells being employed for oxidizer injection and one or both wells being employed for synthesis gas and other fluid production, and the injection and production can be done simulataneously or in a cyclic manner, which may include any unpaired infill wells which may be used as part of the system or standalone. In the cyclic process, after the synthesis gas production has dropped to non-commercial rates, the process may be re-started or increased by re-starting or increasing oxidizer injection. Various types of infill wells may variously be producing or injecting the various fluids or chemicals, in concert as a system with other nearby wells or not. As can be seen, then, existing wells from the thermal recovery apparatus can be used for injecting the oxidizing agent (with or without steam or other additives) and producing the synthesis gas or constituent components thereof (such as, for example, hydrogen). Alternatively, an operator can use the existing thermal recovery apparatus but drill additional wells for injection and/or production, such as for example drilling new wells into the water in the lower region of the reservoir or into the steam chamber that has formed. Existing steam injection wells can be used for a mixed oxygen/steam injectant where the wells have specifications sufficient for the desired level of oxygen, which would be ascertainable by the skilled person, and oxygen can be injected in only some of the injection wells where multiple injection wells are employed, or in a cyclic manner and/or gradational manner. The method is not limited to horizontal wells such as those used in SAGD operations, but also can be done with any well configurations including but not limited to vertical and deviated and multilateral wells across various combinations of distances and timescales. Injection or production can either occur near the higher areas of the reservoir or lower areas of the reservoir including in some appropriate cases somewhat above and below the reservoir. Dual completion within the same wellbores can allow areas of a well to be producing at the same or different times as injecting. Flow control devices can be used such that injection or production may be concentrated variably to various places along the length of a horizontal wellbore such that, for example, oxidizer and steam are injected toward the toe of one of the wells in a well pair, while production occurs toward the heel of the corresponding paired well.

The method can be done with steam injection into the reservoir. The steam can be injected coincident with or in parallel to or in a cyclic manner with the injection of the oxidizer at any ratios. Further, chemicals known to the skilled person can also be co-injected with the oxidizing agent (with or without steam) which accelerate precipitation of carbonates within the reservoir, thus allowing storage of some carbon in a solid form in the reservoir rather than as a gas. Common carbonates include CaCO₃ and CaMg(CO₃)₂. The injectant could include one or more of boiler blowdown water, calcium hydroxide, raw sewage, sea water, and wastewater streams, as selectable by one skilled in the art. This acceleration of carbonate or other carbon solids formation can be done in similar projects where the goal is to accelerate the precipitation of carbon oxides into solid storage format which can help improve volume and pressure constraints, and to reduce the mobility of carbon through geological systems from which they might eventually leak to surface. Embodiments may include carbon sequestration projects, also known as carbon capture and storage projects, which have become popular in response to greenhouse gas and air pollution concerns. In these cases, carbon oxides may be captured from a carbon oxide rich source such as exhaust emissions from coal or natural gas fueled electricity or steam or heat or power generators, or from direct air capture and injection methods.

The synthesis gas or hydrogen enriched gas produced from methods according to the present invention may be used to generate power via its combustion as fuel to generate steam that is used to turn a turbine which in turn, generates electricity. Another embodiment involves using the produced synthesis gas or hydrogen enriched gas to be used to generate electricity within fuel cells. The synthesis gas or hydrogen enriched gas may also be used as a chemical feedstock, for upgrading or refining fuels, or creating other products including but not limited to methanol or ammonia. The synthesis gas or hydrogen enriched gas may also be fed into a steam methane reformation process, with or without pre-treating or augmentation from other supplies of hydrocarbon fuels including but not limited to methane, oil, coal, or natural gas, wherein the surplus of any hydrogen might be extracted with or without full or partial implementation of carbon capture and/or sequestration or storage techniques.

In some embodiments of the present invention, equipment related to oxygen generation can provide additional utility. For example, an air separation unit (ASU) is commonly used to extract oxygen from an air supply, and nitrogen is one byproduct from the separation process. The synthesis gas produced by embodiments according to the present invention includes hydrogen which can be extracted from the synthesis gas by known membrane technologies. The nitrogen can then be combined with the hydrogen using waste heat from the process to produce ammonia. Another example is electrolysis for production of oxidizer and hydrogen near these sites which takes economic advantage of the oxygen output usually vented, and the additional hydrogen made from electrolysis can also be consumed on site, for example in the production of electricity or steam or fueling of fuel cell vehicles, or transported away by pipes or vessels by road, rail, barge/ship, or aircraft such as dirigibles, ground effect vehicles, hovercraft, and other aircraft.

In another embodiment, hot produced synthesis gas or hydrogen and/or hydrocarbons and/or dihydrogen oxide can be passed through a heat exchange system to recover heat. This recovered heat can be used downstream of the ASU to heat the separated oxygen stream before injection, thereby enhancing synthesis gas formation reactions within the reservoir. By reducing the heat of the hydrogen stream, this can aid in liquefying the hydrogen for transport. This recovered heat can also be used for generating electricity or other cascading heat systems such as beer brewing, alcohol distillation, greenhouses, German-style thermal baths, Finnish-style saunas, food processing, or other uses.

The present methods use a post-steamed reservoir, or post-steamed volumes within a reservoir which may still be undergoing steam injection elsewhere, and inject an oxidizer into the reservoir which when it oxidizes the oil (and gas) in the reservoir, heats the reservoir to a temperature where gasification and water-gas shift reactions take place between the petroleum and water within the reservoir by continuously or intermittently injecting oxygen into the reservoir to cause in situ combustion reactions to occur that heat the reservoir to the preferred temperature between 400 and 700° C. This temperature range may be transiently reached or exceeded at interstitial scale or within regions of a reservoir and does not necessitate the entire average reservoir temperature to be within this range.

While the reservoir is being heated and is at elevated temperature, gasification and water-gas shift and aquathermolysis reactions occur with consequent production of hydrogen, hydrogen sulphide, carbon monoxide, carbon dioxide, and steam (water vapour). As the reactions occur in the reservoir, the gas components collect within the reservoir space but tend to rise due to buoyancy effects in the reservoir where the mobilized oil collects around the injection well sustaining the reactions there and the gases rise upwards towards the production well above and collect in the reservoir. The synthesis gas and other fluids are produced from the reservoir through the production well. In another embodiment, the injection well may also be in the upper part of a reservoir and inject intermittently or continuously, potentially in concert with intermittent or continuous production from a production well.

As oxygen is injected into the reservoir, a reactive zone is created within the reservoir. The reactive zone is characterized by the zone with temperature that is higher than the original reservoir temperature. In the reactive zone, the temperature can rise above 450° C., and at the reaction front the temperature can exceed 900° C. With temperatures more than 400° C., gasification reactions occur within the hot zone which generate hydrogen which can be exclusively produced by the upper production well to the surface. Within the hot zone around the injection well, heated oil drains and accumulates around the injection well thus supplying more fuel for the reactions that occur around the injection well. In another embodiment, the production well for gas and oil can be the same well, for example if a high-volume multi-phase pump such as a jet or venturi pump is placed lower in the reservoir, or other types of pumps including but not limited to progressive cavity pumps or electric submersible pumps are submersed to pull liquids and solids up a production string that is separate from a gas production tubing or well casing, then the intake for synthetic gas or hydrogen-enriched gas might be lower in the reservoir. This embodiment may or may not involve perforations or inflow/outflow areas or inlet/outlet screens at more than one reservoir elevation.

The key to the method is to conduct in situ gasification reactions within a reservoir where a well on production produces synthesis gas or hydrogen-enriched gas to the surface.

The synthesis gas generated from the methods taught here may be used to generate power, heat, combusted to produce steam which may be used to generate power, or steam for other in situ oil recovery processes, or as a feedstock material for producing other chemicals including fuel, plastic, methanol, urea, hydrogen, sulphur, etc. Hydrogen separated from the synthesis gas may be used to power steam production, tank heating, thermally-assisted emulsion dewatering, diluent recovery, biocide, spill site remediation, and other activities at the facility.

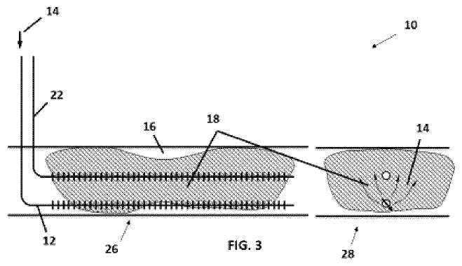

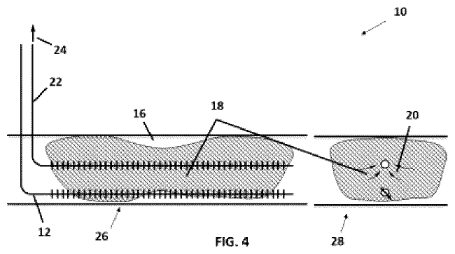

As shown in the exemplary synthesis gas production system 10 illustrated in FIG. 3 side view 26 and cross sectional view 28, the oxidizing agent 14 flows into the reaction zone 18 (formerly the SAGD steam chamber) of the reservoir 16 through an oxidizer injection well 12 (which may formerly have been the production well of a conventional SAGD system) and reacts allowing combustion of the portion of the oxidizable fluids and/or solids to cause thermal cracking (thermolysis), aquathermolysis, gasification, and/or water-gas shift reactions to occur within the reservoir 16 to form synthesis gas 20. In this step, either of the two wells 22, 12 (the upper or lower wells) could be used as the injection well 12. As shown in FIG. 4, after sufficient oxidizing agent 14 has been injected or the pressure of the reservoir 16 has reached a maximum threshold (set by the fracturing pressure of the reservoir 16 or by regulation or preference), injection stops and the gas production well 22 (which may formerly have been the injection well of a conventional SAGD system) is turned on and synthesis gas 20 and other reservoir fluids are produced to the surface as a produced gas 24. In this step, either of the two wells 22, 12 (the upper or lower one) can be used for the production well 22.

The method illustrated in FIGS. 3 and 4 can be repeated in a cyclic manner—after the production stage in FIG. 4 is no longer producing produced gas 24, injection of the oxiding agent 14 can resume and the process may be repeated multiple times.

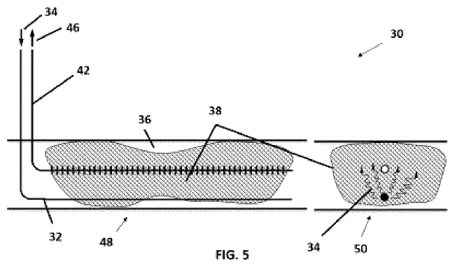

In another alternate synthesis gas production system 30, as shown in FIG. 5 in side view 48 and cross sectional view 50, after the steam-based recovery process has stopped, the oxidizing agent 34 is injected through the oxidizer injection well 32 (which may formerly have been the production well of a conventional SAGD system) into the reaction zone 38 (formerly the SAGD steam chamber) of the reservoir 36 and the produced gas 46 is produced from the reservoir 36 with other reservoir fluids through the gas production well 42 (which may formerly have been the injection well of a conventional SAGD system) simultaneously with the oxidizing agent 34 injection.

The foregoing is considered as illustrative only of the principles of the present invention. The scope of the claims should not be limited by the exemplary embodiments set forth in the foregoing, but should be given the broadest interpretation consistent with the specification as a whole.

1. A method of repurposing a thermal hydrocarbon recovery system to produce synthesis gas from a post-steamed, hydrocarbon-depleted portion of a reservoir after termination of hydrocarbon recovery operations, the thermal hydrocarbon recovery system comprising at least one well from surface to the reservoir, the method comprising the steps of:
a. operating the thermal hydrocarbon recovery system to mobilize and extract hydrocarbon from the reservoir through steam injection and mobilized hydrocarbon production using the at least one well, resulting in the post-steamed, hydrocarbon-depleted portion of the reservoir adjacent the at least one well containing oxidizable materials, invested heat and injected steam;
b. terminating the steam injection and terminating the operating of the thermal hydrocarbon recovery system;
c. after terminating of the operating of the thermal hydrocarbon recovery system, injecting an oxidizing agent into the post-steamed portion of the reservoir through the at least one well to form a reaction zone in the post-steamed, hydrocarbon-depleted portion of the reservoir and cause combustion of the oxidizable materials therein in the presence of the invested heat and the injected steam;
d. allowing the combustion of the oxidizable materials in the reaction zone to cause at least one of thermal cracking, aquathermolysis, gasification, and water-gas shift reactions to occur within the post-steamed, hydrocarbon-depleted portion of the reservoir to form synthesis gas; and
e. producing at least one constituent component of the synthesis gas to surface through the at least one well.

2. The method of claim 1 wherein at least one of additional steam, solvent, carbonate, boiler blowdown water, calcium hydroxide, raw sewage, sea water, and wastewater is co-injected with the oxidizing agent.

3. The method of claim 1 wherein the oxidizing agent is selected from air and oxygen.

4. The method of claim 1 wherein the at least one well is closed off after step c. to allow the combustion to cause the at least one of thermal cracking, aquathermolysis, gasification, and water-gas shift reactions of step d.

5. The method of claim 1 wherein the synthesis gas comprises hydrogen and carbon oxides.

6. The method of claim 5 wherein the at least one constituent component is the hydrogen, the method further comprising the step after step d. of using a membrane to allow production of only the hydrogen to the surface.

7. The method of claim 1 wherein steps c. to e. are repeated when the at least one constituent component of the synthesis gas being produced to the surface through the at least one well drops below a selected threshold volume.

8. The method of claim 1 wherein the thermal hydrocarbon recovery system is a steam-assisted gravity drainage system and the at least one well is an injector well and a producer well, and either or both of the injector well and the producer well is used for the steps of injecting the oxidizing agent and producing the at least one constituent component of the synthesis gas to the surface.

9. The method of claim 8 wherein the steam-assisted gravity drainage system comprises at least one infill well and the at least one well comprises the at least one infill well.

10. The method of claim 1 wherein the at least one well is at least one of a horizontal well, a vertical well, a deviated well and a multilateral well.

11. The method of claim 1 wherein the at least one well is a dual completion well, wherein the steps of injecting the oxidizing agent and producing the at least one constituent component of the synthesis gas to the surface occur at different portions of the dual completion well.

12. The method of claim 1 wherein the at least one well comprises flow control devices to control where along the at least one well the injecting of the oxidizing agent and the producing of the at least one constituent component of the synthesis gas occur.

13. The method of claim 2 wherein the co-injecting of the at least one of the additional steam, solvent, carbonate, boiler blowdown water, calcium hydroxide, raw sewage, sea water, and wastewater accelerates precipitation of solid carbonates within the post-steamed portion of the reservoir.

14. The method of claim 8 wherein the producer well is provided with a multi-phase pump configured to pump both the mobilized hydrocarbon and the at least one constituent component of the synthesis gas.

15. A method for generating and storing carbonate as a solid in a subsurface reservoir, the method comprising the steps of:
a. operating a thermal hydrocarbon recovery system to mobilize and extract hydrocarbon from the subsurface reservoir through steam injection and mobilized hydrocarbon production using at least one well, resulting in a post-steamed, hydrocarbon-depleted portion of the subsurface reservoir adjacent the at least one well containing oxidizable materials, invested heat and injected steam;
b. terminating the steam injection and terminating the operating of the thermal hydrocarbon recovery system;
c. after terminating of the operating of the thermal hydrocarbon recovery system, injecting an oxidizing agent into the post-steamed portion of the reservoir through the at least one well to form a reaction zone in the post-steamed, hydrocarbon-depleted portion of the reservoir and cause combustion of the oxidizable materials therein in the presence of the invested heat and the injected steam;
d. co-injecting at least one of additional steam, solvent, carbonate, boiler blowdown water, calcium hydroxide, raw sewage, sea water, and wastewater with the oxidizing agent;
e. allowing the combustion of the oxidizable materials in the reaction zone to cause at least one of thermal cracking, aquathermolysis, gasification, and water-gas shift reactions to occur within the post-steamed, hydrocarbon-depleted portion of the reservoir to form synthesis gas;
e. allowing the at least one of additional steam, solvent, carbonate, boiler blowdown water, calcium hydroxide, raw sewage, sea water, and wastewater to react with a first constituent of the synthesis gas to form solid carbonate; and
f. producing a second constituent component of the synthesis gas to surface through the at least one well while retaining the solid carbonate in the subsurface reservoir.
